(19) United States
(12) Patent Application Publication
(10) Pub. No.: US 2025/0096249 A1
(43) Pub. Date: Mar. 20, 2025

(54) BATTERY AND METHOD FOR PRODUCING BATTERY

(71) Applicant: TOYOTA JIDOSHA KABUSHIKI KAISHA, Toyota-shi (JP)

(72) Inventors: Ryo ASAKURA, Sunto-gun (JP); Shinya SHIOTANI, Nagoya-shi (JP); Sakina KANEKO, Fujisawa-shi (JP)

(73) Assignee: TOYOTA JIDOSHA KABUSHIKI KAISHA, Toyota-shi (JP)

(21) Appl. No.: 18/824,494

(22) Filed: Sep. 4, 2024

(30) Foreign Application Priority Data
Sep. 20, 2023 (JP) 2023-152509

(51) Int. Cl. H01M 4/40; H01M 4/02; H01M 4/04

(52) U.S. Cl. CPC H01M 4/405; H01M 4/0445; H01M 2004/027

(57) ABSTRACT

A main object of the present disclosure is to provide a battery with excellent discharge capacity properties. The present disclosure achieves the object by providing a battery utilizing a deposition and dissolution reaction of a metal lithium as an anode reaction, the battery including: layers in the order of an anode current collector, a metal layer, an electrolyte layer, and a cathode active material layer in a thickness direction, wherein the metal layer contains a Li—Mg alloy phase and a Li—In alloy phase.

### TECHNICAL FIELD

The present disclosure relates to a battery, and a method for producing the same.

### BACKGROUND ART

A battery usually includes an electrolyte layer between a cathode active material layer and an anode active material layer. Also, in the field of batteries, a battery utilizing a deposition and dissolution reaction of a metal lithium as an anode reaction has been known. For example, Patent Literature 1 discloses an all solid state battery utilizing the deposition and dissolution reaction of a metal lithium as an anode reaction.

### CITATION LIST

### Patent Literature

Patent Literature 1: Japanese Patent Application Laid-Open (JP-A) No. 2020-184513

### SUMMARY OF DISCLOSURE

### Technical Problem

In the battery utilizing the deposition and dissolution reaction of the metal lithium as an anode reaction, usually, when the battery is produced, a general anode active material layer (a layer containing an anode active material particle that absorbs and releases Li) is not arranged, but the anode active material layer (Li-containing layer) is formed by the initial charge, and thus it is advantageous in easily improving the energy density. Meanwhile, in the battery utilizing the deposition and dissolution reaction of the metal lithium as an anode reaction, there is a room for further improvement in discharge capacity properties.

The present disclosure has been made in view of the above circumstances and a main object thereof is to provide a battery of which discharge capacity properties are excellent.

### Solution to Problem

[1]

A battery utilizing a deposition and dissolution reaction of a metal lithium as an anode reaction, the battery comprising:
layers in the order of an anode current collector, a metal layer, an electrolyte layer, and a cathode active material layer in a thickness direction, wherein
the metal layer contains a Li—Mg alloy phase and a Li—In alloy phase.
   [2]

The battery according to [1], wherein in the metal layer, the Li—In alloy phase is dispersed to the Li—Mg alloy phase.

[3]

The battery according to [1] or [2], wherein in the metal layer, a proportion of In with respect to a total of In and Mg is 5 at % or more and 60 at % or less.

[4]

The battery according to any one of [1] to [3], wherein in the metal layer, a proportion of In with respect to a total of In and Mg is 25 at % or more and 60 at % or less.

[5]

The battery according to any one of [1] to [4], wherein a size of the Li—Mg alloy phase is 0.1 μm or more and 5 μm or less.

[6]

The battery according to any one of [1] to [5], wherein the metal layer does not contain a binder.

[7]

The battery according to any one of [1] to [6], wherein the electrolyte layer is a solid electrolyte layer containing a solid electrolyte.

[8]

The battery according to any one of [1] to [7], wherein the solid electrolyte is a sulfide solid electrolyte.

[9]

A battery utilizing a deposition and dissolution reaction of a metal lithium as an anode reaction, the battery comprising:
layers in the order of an anode current collector, a metal layer, an electrolyte layer, and a cathode active material layer in a thickness direction, wherein
the metal layer contains a Mg—In alloy.
   [10]

The battery according to [9], wherein the metal layer includes a metal phase that is a Mg—In alloy phase of the Mg—In alloy.

[11]

The battery according to [9] or [10], wherein the metal layer is a vapor deposition layer.

[12]

The battery according to [9], wherein the metal layer contains a particle of the Mg—In alloy.

[13]

A method for producing a battery utilizing a deposition and dissolution reaction of a metal lithium as an anode reaction, the method comprising:
a metal layer forming step of forming a metal layer including a Mg—In alloy phase by a vapor deposition method; and
an assembling step of assembling the battery including layers in the order of an anode current collector, the metal layer, an electrolyte layer, and a cathode active material layer in a thickness direction.
   [14]

The method for producing the battery according to [13], further comprising a charging step of charging the battery to form a Li—Mg alloy phase and a Li—In alloy phase from the Mg—In alloy phase included in the metal layer, after the assembling step.

### Advantageous Effects of Disclosure

The battery in the present disclosure exhibits an effect of excellent discharge capacity properties.

### BRIEF DESCRIPTION OF DRAWINGS

FIGS. 1A and 1B are schematic cross-sectional views exemplifying the battery in the present disclosure.

FIGS. 2A to 2D are explanatory views explaining the states at the time of charging the battery in the present disclosure.

FIGS. 3A to 3C are explanatory views explaining the states at the time of discharging the battery in the present disclosure.

FIG. 4 is a flow chart exemplifying the method for producing the battery in the present disclosure.

FIG. 5 is the result of a charge and discharge test in evaluation cells produced in Examples 1 to 5 and Comparative Examples 1 and 2.

FIG. 6 is the result of a charge and discharge test in evaluation cells produced in Examples 1 to 5 and Comparative Examples 1 and 2.

FIG. 7 is a cross-sectional SEM image in the evaluation cell produced in Example 3.

### DESCRIPTION OF EMBODIMENTS

The battery and the method for producing the same in the present disclosure will be hereinafter explained in details with reference to drawings. Each drawing described as below is a schematic view, and the size and the shape of each portion are appropriately exaggerated in order to be understood easily.

### A. Battery

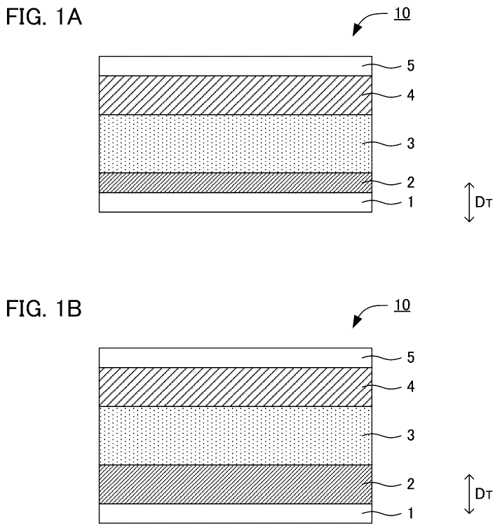

FIGS. 1A and 1B are schematic cross-sectional views exemplifying the battery in the present disclosure. In specific, FIG. 1A is a schematic cross-sectional view exemplifying the battery before the initial charge, and FIG. 1B is a schematic cross-sectional view exemplifying the battery after the initial charge.

As shown in FIGS. 1A and 1B, battery 10 includes layers in the order of anode current collector 1, metal layer 2, electrolyte layer 3, and cathode active material layer 4 in thickness direction Dr. Usually, cathode current collector 5 is arranged in the opposite side to the electrolyte layer 3 on the basis of the cathode active material layer 4. Also, as shown in FIG. 1A, in the battery 10 before the initial charge, the metal layer 2 contains a Mg—In alloy. The metal layer 2 is typically a vapor deposition layer including a Mg—In alloy phase. Meanwhile, when the battery 10 shown in FIG. 1A is charged, the Mg—In alloy phase reacts with Li, and a Li—Mg alloy phase and a Li—In alloy phase are formed from the Mg—In alloy phase. As shown in FIG. 1B, in the battery 10 after the initial charge, the metal layer 2 contains the Li—Mg alloy phase and the Li—In alloy phase.

According to the present disclosure, the metal layer includes Mg and In, and thus a battery with excellent discharge capacity properties may be achieved. As described above, in the battery utilizing the deposition and dissolution reaction of the metal lithium as an anode reaction, usually, when the battery is produced, a general anode active material layer (such as a layer containing an anode active material particle that absorbs and releases Li) is not arranged, but the anode active material layer (Li-containing layer) is formed by the initial charge, and thus it is advantageous in easily improving energy density. Meanwhile, in the battery utilizing the deposition and dissolution reaction of the metal lithium as an anode reaction, there is a room for further improvement in discharge capacity properties.

In contrast, in the present disclosure, the metal layer including Mg and In is used. By using such a metal layer, excellent discharge capacity properties can be obtained. The reason why the excellent discharge capacity properties can be obtained is presumably because increase of resistance in the anode can be inhibited in the end stage of discharge when the metal layer including Mg and In is used. The effects that can be obtained in the present disclosure will be hereinafter explained in details with reference to FIGS. 2A to 2D and FIGS. 3A to 3C.

As shown in FIG. 2A, battery 10 includes layers in the order of anode current collector 1, metal layer 2, electrolyte layer 3, cathode active material layer 4, and cathode current collector 5 in a thickness direction. The metal layer 2 includes a Mg—In alloy phase. Next, as shown in FIG. 2B, when the charge of the battery 10 begins, first, a Li—In alloy phase is formed from a part of the Mg—In alloy phase. Since the reaction potential of Li intercalation and desorption of In is higher than that of Mg, In reacts with Li faster than Mg, and the Li—In alloy phase is formed. Next, as shown in FIGS. 2C and 2D, when the charge of the battery 10 proceeds, a Li—Mg alloy phase is formed in addition to the Li—In alloy phase. The Li—In alloy phase is formed before the Li—Mg alloy phase, and thus the state where the Li—In alloy phase is dispersed to the Li—Mg alloy phase, is obtained.

Next, as shown in FIG. 3A, when the charged battery 10 is discharged, Li included in the metal layer 2 moves to the cathode active material layer 4 through the electrolyte layer 3. On this occasion, since the reaction potential of Li intercalation and desorption of Mg is lower than that of In, first, Li is desorbed from the Li—Mg alloy phase. As shown in FIG. 3B, the Li—In alloy phase has high Li ion conductivity, and thus excellent ion conduction path is formed. As shown in FIG. 3C, the Li—In alloy phase is presumably maintained also in the end stage of discharge, and thereby the increase of resistance in the anode is presumably inhibited. As a result, it is presumed that the excellent discharge capacity properties can be obtained. The battery in the present disclosure can be roughly classified into two embodiments depending on State of Charge (SOC). The first embodiment and the second embodiment of the battery in the present disclosure will be hereinafter separately explained.

### 1. First Embodiment

As shown in FIG. 3A, battery 10 in the first embodiment includes layers in the order of anode current collector 1, metal layer 2, electrolyte layer 3, and cathode active material layer 4 in a thickness direction. Further, the metal layer 2 contains a Li—Mg alloy phase and a Li—In alloy phase.

### (1) Anode

The anode in the first embodiment includes an anode current collector. Examples of the material for the anode current collector may include SUS, copper, nickel, and carbon. Examples of the shape of the anode current collector may include a foil shape. The thickness of the anode current collector is, for example, 1 μm or more and 500 μm or less.

The anode includes a metal layer. The metal layer contains a Li—Mg alloy phase and a Li—In alloy phase. The Li—Mg alloy phase is a metal phase of an alloy including Li and Mg, and it may be a metal phase of a binary alloy including Li and Mg, and it may be a metal phase of an alloy including other elements in addition to Li and Mg. In the latter case, it is preferable that Li and Mg are the main components in the Li—Mg alloy phase. “Main components” means that the proportion (at %) is the most among the components included in the metal phase. In the Li—Mg alloy phase, the proportion of the total of Li and Mg with respect to all the elements is, for example, 50 at % or more, may be 70 at % or more, and may be 90 at % or more.

The Li—In alloy phase is a metal phase of an alloy including Li and In, and it may be a metal phase of a binary alloy including Li and In, and it may be a metal phase of an alloy including other elements in addition to Li and In. In the latter case, it is preferable that Li and In are the main components in the Li—In alloy phase. In the Li—In alloy phase, the proportion of the total of Li and In with respect to all the elements is, for example, 50 at % or more, may be 70 at % or more, and may be 90 at % or more.

The metal layer contains both of the Li—In alloy phase and the Li—Mg alloy phase. Above all, in the metal layer, it is preferable that the Li—In alloy phase is dispersed to the Li—Mg alloy phase. In other words, it is preferable that a sea-island structure, wherein the Li—Mg alloy phase is the sea and the Li—In alloy phase is the island, is formed. The reason therefor is to inhibit the increase of resistance in the anode in the end stage of discharge. There are no particular limitations on the size of the Li—In alloy phase, but for example, it is 0.1 μm or more and 5 μm or less. The size of the Li—In alloy phase can be obtained from distribution of In by SEM-EDX. The size of the Li—In alloy phase is an average value of the sizes of 100 pieces or more of the samples measured.

In the metal layer, there are no particular limitations on the proportion of In with respect to the total of In and Mg, which is In/(In+Mg). In/(In+Mg) is, for example, 5 at % or more, may be 10 at % or more, may be 15 at % or more, may be 20 at % or more, and may be 25 at % or more. If the value of In/(In+Mg) is too small, there is a possibility that the effect of improving the discharge capacity properties by In may not be sufficiently exhibited. Meanwhile, In/(In+Mg) is, for example, 90 at& or less, may be 80 at % or less, may be 70 at % or less, and may be 60 at % or less. If the value of In/(In+Mg) is too large, there is a possibility that the effect of improving capacity durability by Mg may not be sufficiently exhibited.

It is preferable that the metal layer does not contain a conductive material. Also, it is preferable that the metal layer does not contain a binder. Also, a Li phase may be formed inside the metal layer. Also, a deposited Li layer may be formed between the metal layer and the electrolyte layer. Also, a deposited Li layer may be formed between the metal layer and the anode current collector.

The metal layer is usually a dense layer. The void of the metal layer (proportion of the area of the void in the cross-section of the metal layer) is, for example, 5% or less, may be 3% or less, and may be 18 or less. Also, in the first embodiment, the thickness of the metal layer is not particularly limited, but for example, it is 5 μm or more and 30 μm or less.

As shown in FIG. 3A, the metal layer 2 may directly contact the anode current collector 1. Similarly, the metal layer 2 may directly contact the electrolyte layer 3. Meanwhile, although not illustrated in particular, an additional layer may be arranged between the metal layer and the anode current collector. Similarly, an additional layer may be arranged between the metal layer and the electrolyte layer. Also, as shown in FIG. 3C, the metal layer 2 after discharge may contain the Li—Mg alloy phase and the Li—In alloy phase. It may depend on the SOC, but the metal layer after discharge may contain a Mg phase not including Li, and the Li—In alloy phase. Similarly, the metal layer after discharge may contain a Mg phase not including Li, and an In phase not including Li.

### (2) Cathode

The cathode in the first embodiment includes a cathode current collector and a cathode active material layer. The cathode active material layer contains at least a cathode active material. Also, the cathode active material layer may contain at least one of an electrolyte, a conductive material, and a binder.

Examples of the cathode active material may include an oxide active material. Examples of the oxide active material may include a rock salt bed type active material such as LiCoO₂ and LiNi_{1/3}Co_{1/3}Mn_{1/3}O₂; a spinel type active material such as LiMn₂O₄ and Li₄Ti₅O₁₂; and an olivine type active material such as LiFePO₄. Examples of the shape of the cathode active material may include a granular shape. The average particle size (D₅₀) of the cathode active material is, for example, 0.5 μm or more and 50 μm or less. The average particle size (D₅₀) refers to a volume accumulation particle size measured by a laser diffraction scattering particle distribution measurement device.

Examples of the electrolyte may include a solid electrolyte. Examples of the solid electrolyte may include an inorganic solid electrolyte such as a sulfide solid electrolyte, an oxide solid electrolyte, and a halide solid electrolyte. The sulfide solid electrolyte preferably contains sulfur (S) as a main component of the anion element. The oxide solid electrolyte preferably contains oxygen (O) as a main component of the anion element. The halide solid electrolyte preferably contains halogen (X) as a main component of the anion. Among these, the sulfide solid electrolyte is preferable.

The sulfide solid electrolyte preferably contains a Li element, an M element (M is at least one kind of P, Sn, Al, Zn, In, Ge, Si, Sb, Ga and Bi), and a S element. Also, the sulfide solid electrolyte may contain a halogen element such as F, Cl, Br and I. Also, in the sulfide solid electrolyte, a part of a S element may be substituted with an O element.

The sulfide solid electrolyte may be a glass (amorphous)-based sulfide solid electrolyte, may be a glass ceramic-based sulfide solid electrolyte, and may be a crystal-based sulfide solid electrolyte. Examples of the crystal phase included in the sulfide solid electrolyte may include a LGPS type crystal phase, a Thio-LISICON type crystal phase, and an argyrodite type crystal phase.

Examples of the sulfide solid electrolyte may include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m, n is a positive number and Z is one of Ge, Zn and Ga), Li₂S—GeS₂, Li₂S—SiS₂—Li₃PO₄, Li₂S—SiS₂-LiₓMO_{y} (provided that x, y is a positive number and M is one of P, Si, Ge, B, Al, Ga and In).

Additional examples of the solid electrolyte may include an organic solid electrolyte such as a polymer electrolyte and a gel electrolyte. Also, as the electrolyte, an electrolyte solution (liquid electrolyte) can be used.

Examples of the conductive material may include a carbon material. Examples of the carbon material may include a particulate carbon material such as acetylene black (AB) and Ketjen black (KB); and a fiber carbon material such as carbon fiber, carbon nanotube (CNT) and carbon nanofiber (CNF). Further, examples of the binder may include a rubber-based binder such as butylene rubber (BR) and styrene butadiene rubber (SBR), and a fluoride-based binder such as polyvinylidene fluoride (PVDF). The thickness of the cathode active material layer is, for example, 1 μm or more and 500 μm or less.

Examples of the material for the cathode current collector may include SUS, aluminum, nickel, and carbon. Examples of the shape of the cathode current collector may include a foil shape. The thickness of the cathode current collector is, for example, 1 μm or more and 500 μm or less.

### (3) Electrolyte Layer

The electrolyte layer in the first embodiment contains at least an electrolyte. The electrolyte is in the same contents as those described in “(2) cathode” above. Above all, the electrolyte layer preferably contains a solid electrolyte as the electrolyte. In other words, the electrolyte layer is preferably a solid electrolyte layer containing a solid electrolyte. A battery including the solid electrolyte layer may be referred to as an all solid state battery. Also, the solid electrolyte layer may contain a binder in addition to the solid electrolyte. The binder is in the same contents as those described in “(2) Cathode” above. Also, the thickness of the electrolyte layer is, for example, 1 μm or more and 500 μm or less.

### (4) Battery

The battery in the first embodiment includes layers in the order of an anode current collector, a metal layer, an electrolyte layer, and a cathode active material layer in a thickness direction. Further, the battery usually includes an outer package for storing these members. Examples of the outer package may include a laminate type outer package and a case type outer package.

The application of the battery is not particularly limited, and examples thereof may include a power source for vehicles such as hybrid electric vehicles (HEV), plug-in hybrid electric vehicles (PHEV), battery electric vehicles (BEV), gasoline-fueled automobiles and diesel powered automobiles. In particular, it is preferably used as a power source for driving hybrid electric vehicles (HEV), plug-in hybrid electric vehicles (PHEV), and battery electric vehicles (BEV). Also, the battery may be used as a power source for moving bodies other than vehicles (such as rail road transportation, vessel and airplane), and may be used as a power source for electronic products such as information processing equipment.

### 2. Second Embodiment

As shown in FIG. 2A, battery 10 in the second embodiment includes layers in the order of anode current collector 1, metal layer 2, electrolyte layer 3, and cathode active material layer 4 in a thickness direction. Further, the metal layer 2 contains a Mg—In alloy. Incidentally, details of each member other than the metal layer 2 are in the same contents as those described for the first embodiment above.

The metal layer contains a Mg—In alloy. The Mg—In alloy is an alloy including Mg and In, and it may be a binary alloy including Mg and In, and may be an alloy including other elements in addition to Mg and In. In the latter case, it is preferable that Mg and In are the main components in the Mg—In alloy. In the Mg—In alloy, the proportion of the total of Mg and In with respect to all the elements is, for example, 50 at % or more, may be 70 at % or more, and may be 90 at % or more.

The metal layer may include a metal phase of the Mg—In alloy (Mg—In alloy phase), and may contain particles of the Mg—In alloy. The particles of the Mg—In alloy are preferably nano particles of which average particle size D₅₀ is 1 μm or less. Also, there are no particular limitations on the proportion of In with respect to the total of In and Mg, which is In/(In+Mg) in the metal layer. The preferable range of In/(In+Mg) is in the same contents as those described in the first embodiment above. Also, it is preferable that the metal layer does not contain a conductive material. Also, it is preferable that the metal layer does not contain a binder. Also, in the second embodiment, the metal layer usually does not contain Li.

The metal layer is usually a dense layer. The void of the metal layer (proportion of the area of the void in the cross-section of the metal layer) is, for example, 5% or less, may be 3% or less, and may be 1% or less. Also, the metal layer may be a vapor deposition layer. It is preferable that the metal layer adheres to the anode current collector. In other words, it is preferable that the metal layer is arranged so as to cover the surface of the anode current collector. A member including the anode current collector and the metal layer arranged on the anode current collector may be referred to as a covered current collector. Also, in the second embodiment, there are no particular limitations on the thickness of the metal layer, and for example, it is 30 nm or more and 5 μm or less, may be 100 nm or more and 3 μm or less, and may be 500 nm or more and 2 μm or less.

The battery in the second embodiment includes layers in the order of an anode current collector, a metal layer, an electrolyte layer, and a cathode active material layer in a thickness direction. Further, the battery usually includes an outer package for storing these members. The constitutions other than the metal layer are in the same contents as those described in “1. First embodiment” above.

### B. Method for Producing Battery

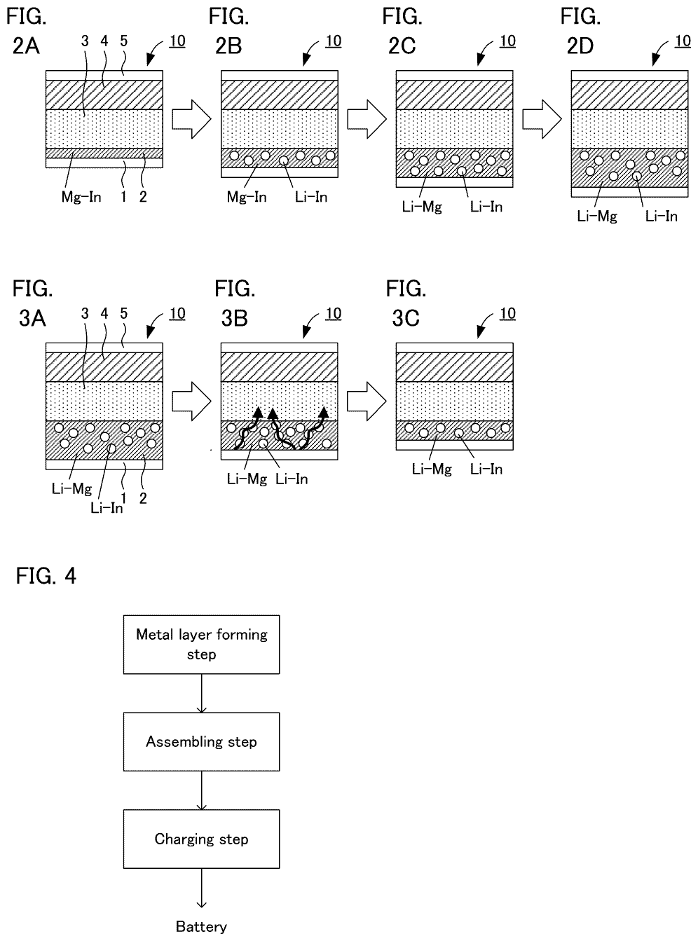

FIG. 4 is a flow-chart exemplifying the method for producing the battery in the present disclosure. As shown in FIG. 4, a metal layer including a Mg—In alloy phase is formed by a vapor deposition method (a metal layer forming step). After that, the battery including layers in the order of an anode current collector, the metal layer, an electrolyte layer, and a cathode active material layer in a thickness direction, is assembled (an assembling step). Thereby, for example, battery 10 shown in FIG. 1A is obtained. After that, the battery is charged to form a Li—Mg alloy phase and a Li—In alloy phase from the Mg—In alloy phase included in the metal layer (a charging step). Thereby, for example, battery 10 shown in FIG. 1B is obtained.

According to the present disclosure, the specified metal layer is formed, and thus a battery with excellent discharge capacity properties is obtained.

### 1. Metal Layer Forming Step

The metal layer forming step in the present disclosure is a step of forming a metal layer including a Mg—In alloy phase by a vapor deposition method. A metal layer obtained by the vapor deposition method is a vapor deposition layer.

Examples of the vapor deposition method may include a physical vapor deposition (PVD) such as ion plating, spattering, and a vacuum vapor deposition. It is preferable that a Mg metal and an In metal are respectively prepared and subjected to a binary deposition.

In the present disclosure, it is preferable that the metal layer is formed on the anode current collector by the vapor deposition method. The reason therefor is that the anode current collector is highly smooth and a metal layer with uniform thickness can be obtained. In this case, the metal layer may be formed directly on the anode current collector. Meanwhile, the metal layer may be formed on the anode current collector interposing an additional layer (such as an additional vapor deposition layer). Meanwhile, in the present disclosure, the metal layer may be formed on the solid electrolyte layer by the vapor deposition method. In this case, the metal layer may be formed directly on the solid electrolyte layer. Meanwhile, the metal layer may be formed on the solid electrolyte layer interposing an additional layer (such as an additional vapor deposition layer).

### 2. Assembling Step

The assembling step in the present disclosure is a step of assembling the battery including layers in the order of an anode current collector, the metal layer, an electrolyte layer, and a cathode active material layer in a thickness direction. There are no particular limitations on the method for assembling the battery, and known methods can be used.

### 3. Charging Step

The charging step in the present disclosure is a step of charging the battery to form a Li—Mg alloy phase and a Li—In alloy phase from the Mg—In alloy phase included in the metal layer. Conditions for charging the battery are appropriately selected depending on the constitution of the battery.

### 4. Battery

The battery to be obtained through each of the above described step is in the same contents as those described in “A. Battery”.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

### <Production of Cathode>

Lithium nickel cobalt aluminate (NCA) was prepared as a cathode active material, a Li₂S—P₂S₅-based sulfide solid electrolyte including LiI and LiBr was prepared as a solid electrolyte (SE), a PVDF-based binder was prepared as a binder, and a vapor grown carbon fiber (VGCF) was prepared as a conductive material. Next, each material was added to a butyl butyrate in the weight ratio of NCA:SE:the binder:the conductive material=84.7:13.4:0.6:1.27, and thereby a cathode slurry was obtained. The obtained cathode slurry was pasted on a cathode current collector (Al foil) in a pasting gap 225 μm, and after that, temporarily dried at 60° C., and then dried at 165° C. for 1 hour. Thereby, a cathode including a cathode current collector and a cathode active material layer was obtained. The weight amount of the cathode active material layer was 18.7 mg/cm², and the designed capacity of the cathode active material layer was 3.0 mAh/cm².

### <Production of Solid Electrolyte Layer>

A Li₂S—P₂S₅-based sulfide solid electrolyte including LiI and LiBr was prepared as a solid electrolyte (SE), and a PVDF-based binder was prepared as a binder. Next, each material was added to a butyl butyrate in the weight ratio of SE:the binder=92.6:7.4, and thereby a slurry for solid electrolyte layer was obtained. The obtained slurry was pasted on a release film in a pasting gap 325 μm, and after that, temporarily dried at a room temperature for 3 hours, and then dried at 165° C. for 1 hour. Thereby, a layered body including the release film and the solid electrolyte layer was obtained. The obtained layered body was punched out into Φ14.5 mm, and the solid electrolyte layers of two punched out members were overlapped, and then pressed at a pressure of 7 tons. After pressing, the released films positioned on both surfaces were peeled off, and an independent solid electrolyte layer was obtained.

### <Production of Anode>

A stainless steel foil (SUS foil) was prepared as an anode current collector. On the SUS foil, a metal layer containing a Mg—In alloy (thickness: 1.0 μm) was formed by a binary deposition using an ion plating method. The targeted composition in the metal layer was Mg:In=90:10 (at % basis), and the actual composition was Mg:In=86:14 (at % basis). Thereby, an anode including the anode current collector and the metal layer was obtained.

### <Production of Evaluation Cell>

The obtained cathode was punched out into Φ11.28 mm, and the obtained anode was punched out into Φ14.5 mm. The independent solid electrolyte layer was disposed between them, and a cathode tab made of Al and an anode tab made of Ni were installed, and then vacuum sealed in a laminate film. A pressure of 392 MPa was applied to the sealed cell by a cold isostatic pressing (CIP). After that, the cell was restrained in 1 MPa using a constant pressure jig in which a spring was inserted, so that the restraining pressure was constant regardless of the volume change of the cell. Thereby, an evaluation cell was obtained.

### Example 2

An evaluation cell was obtained in the same manner as in Example 1 except that the targeted composition in the metal layer was changed to Mg:In=67:33 (at % basis). The actual composition in the metal layer was Mg:In=64:36 (at % basis).

### Example 3

An evaluation cell was obtained in the same manner as in Example 1 except that the targeted composition in the metal layer was changed to Mg:In=50:50 (at % basis). The actual composition in the metal layer was Mg:In=46:54 (at % basis).

### Example 4

An evaluation cell was obtained in the same manner as in Example 1 except that the targeted composition in the metal layer was changed to Mg:In=33:67 (at % basis). The actual composition in the metal layer was Mg:In=34:66 (at % basis).

### Example 5

An evaluation cell was obtained in the same manner as in Example 1 except that the targeted composition in the metal layer was changed to Mg:In=10:90 (at % basis). The actual composition in the metal layer was Mg:In=12:88 (at % basis).

### Comparative Example 1

An evaluation cell was obtained in the same manner as in Example 1 except that a metal layer containing a Mg metal was formed as the metal layer.

### Comparative Example 2

An evaluation cell was obtained in the same manner as in Example 1 except that a metal layer containing an In metal was formed as the metal layer.

### [Evaluation]

### <Charge and Discharge Test>

To the evaluation cells obtained in Examples 1 to 5 and Comparative Examples 1 to 2, first, charge and discharge were conducted at 60° C. by a constant current (current density: 0.15 mA/cm², equivalent to about 0.05 C)−constant voltage (cut-off current density: 0.03 mA/cm², equivalent to about 0.01 C) test in a range of the cut-off voltage: 4.2 V to 3.0 V.

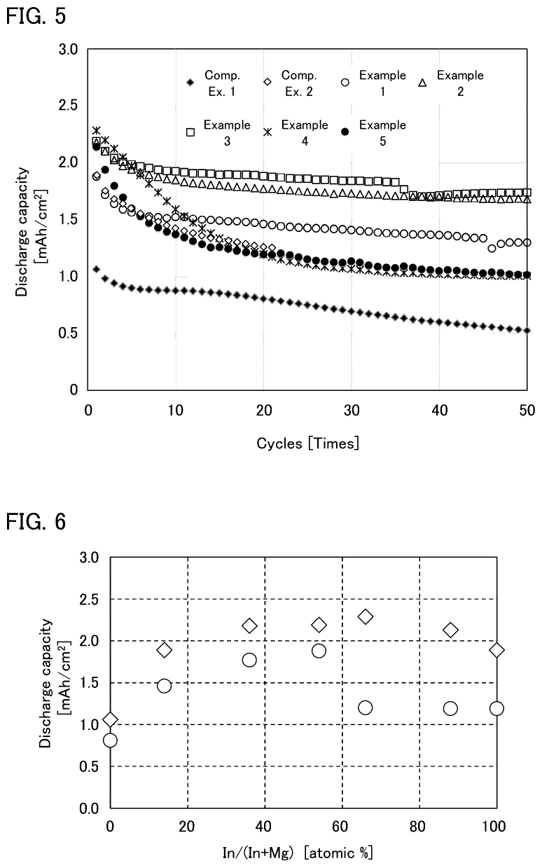

Next, as a cycle test, a constant current (current density: 0.60 mA/cm², equivalent to about 0.05 C)−constant voltage (only during charge, cut-off current density: 0.03 mA/cm², equivalent to about 0.01 C) test was conducted at 25° C. in a range of the cut-off voltage: 4.2 V to 3.0 V. The results are shown in FIG. 5. Also, the initial discharge capacity and the discharge capacity after 20 cycles in the cycle test are shown in Table 1 and FIG. 6.

TABLE 1

| | | Initial | |
|---|---|---|---|
| | Metal layer | discharge | Discharge capacity |
| | composition | capacity | after 20 cycles |
| | [atomic %] | [mAh/cm²] | [mAh/cm²] |
| Comp. Ex. 1 | Mg:In = 100:0 | 1.06 | 0.81 |
| Comp. Ex. 2 | Mg:In = 0:100 | 1.89 | 1.26 |
| Example 1 | Mg:In = 86:14 | 1.89 | 1.46 |
| Example 2 | Mg:In = 64:36 | 2.18 | 1.77 |
| Example 3 | Mg:In = 46:54 | 2.19 | 1.88 |
| Example 4 | Mg:In = 34:66 | 2.28 | 1.20 |
| Example 5 | Mg:In = 12:88 | 2.14 | 1.19 |

As shown in Table 1, FIG. 5 and FIG. 6, higher discharge capacity was respectively obtained in Examples 1 to 5 compared to that of Comparative Examples 1 and 2. In more specific, as shown in FIG. 6, the discharge capacity higher than a discharge capacity presumed from a straight line connecting Comparative Examples 1 and 2, was respectively obtained in Examples 1 to 5. Among Examples 1 to 5, the discharge capacity after 20 cycles of Examples 1 to 3 was respectively kept high, and it was confirmed that they are superior in cycle properties. In particular, it was confirmed that both the initial discharge capacity and the discharge capacity after 20 cycles of Examples 2 and 3 were remarkably high.

### <SEM Observation>

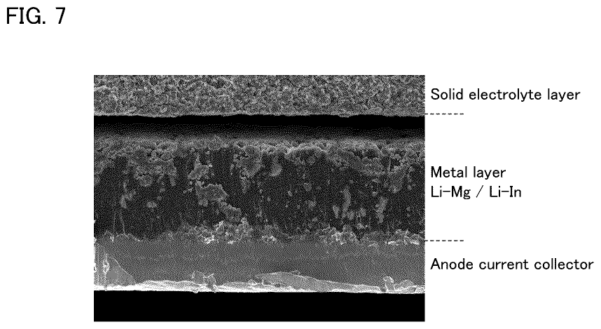

A cross-section observation with a scanning electron microscope (SEM) was performed to the evaluation cell obtained in Example 3. In specific, an initial charge at 60° C. was conducted in the same conditions as the above, and the SEM observation of the cross-section in a secondary electron image was performed with applied voltage of 5 kV. The results are shown in FIG. 7. As shown in FIG. 7, the metal layer disposed between the solid electrolyte layer and the anode current collector was increased from 1.0 μm before the initial charge to about 15 μm. This occurred because the Mg and the In included in the metal layer were respectively alloyed with Li. Also, although not illustrated in particular, when an element mapping by an energy dispersion X-ray spectroscopy (EDX) was analyzed, it was confirmed that the Mg was comparatively uniformly dispersed in the metal layer. In contrast, it was confirmed that the In was locally dispersed. In other words, it was confirmed that the sea-island structure, wherein the Li—Mg alloy phase was the sea and the Li—In alloy phase was the island, was formed.

The reaction potential of the Li intercalation and desorption of the Mg is lower than 0.1 V (vs Li/Li⁺), and the reaction potential of the Li intercalation and desorption of the In is about 0.1 V to 0.6 V (vs Li/Li⁺). In consideration of such a relationship, it is presumed that the Li desorption from the Li—Mg alloy phase occurred first during discharge, and at that time, the Li—In alloy phase worked as the Li ion conduction path to increase the discharge capacity. In particular, in Example 3, it is presumed that the state of the Li—In alloy phase dispersed locally was effective to the Li ion conductivity. Also, in consideration of the binary phase diagram of the Mg—In alloy, the Mg—In alloy (before initial charge) in Example 3 was in a state of including B″ phase while including plurality of other β phases, and such a state gave an influence to a dispersion state of the Li—In alloy phase after the initial charge.

### REFERENCE SINGS LIST

1 anode current collector
2 metal layer
3 electrolyte layer
4 cathode active material layer
5 cathode current collector
10 battery

What is claimed is:

1. A battery utilizing a deposition and dissolution reaction of a metal lithium as an anode reaction, the battery comprising:
layers in the order of an anode current collector, a metal layer, an electrolyte layer, and a cathode active material layer in a thickness direction, wherein
the metal layer contains a Li—Mg alloy phase and a Li—In alloy phase.

2. The battery according to claim 1, wherein in the metal layer, the Li—In alloy phase is dispersed to the Li—Mg alloy phase.

3. The battery according to claim 1, wherein in the metal layer, a proportion of In with respect to a total of In and Mg is 5 at % or more and 90 at % or less.

4. The battery according to claim 1, wherein in the metal layer, a proportion of In with respect to a total of In and Mg is 25 at % or more and 60 at % or less.

5. The battery according to claim 1, wherein a size of the Li—Mg alloy phase is 0.1 μm or more and 5 μm or less.

6. The battery according to claim 1, wherein the metal layer does not contain a binder.

7. The battery according to claim 1, wherein the electrolyte layer is a solid electrolyte layer containing a solid electrolyte.

8. The battery according to claim 7, wherein the solid electrolyte is a sulfide solid electrolyte.

9. A battery utilizing a deposition and dissolution reaction of a metal lithium as an anode reaction, the battery comprising:
layers in the order of an anode current collector, a metal layer, an electrolyte layer, and a cathode active material layer in a thickness direction, wherein
the metal layer contains a Mg—In alloy.

10. The battery according to claim 9, wherein the metal layer includes a metal phase that is a Mg—In alloy phase of the Mg—In alloy.

11. The battery according to claim 10, wherein the metal layer is a vapor deposition layer.

12. The battery according to claim 9, wherein the metal layer contains a particle of the Mg—In alloy.

13. A method for producing a battery utilizing a deposition and dissolution reaction of a metal lithium as an anode reaction, the method comprising:
a metal layer forming step of forming a metal layer including a Mg—In alloy phase by a vapor deposition method; and
an assembling step of assembling the battery including layers in the order of an anode current collector, the metal layer, an electrolyte layer, and a cathode active material layer in a thickness direction.

14. The method for producing the battery according to claim 13, further comprising a charging step of charging the battery to form a Li—Mg alloy phase and a Li—In alloy phase from the Mg—In alloy phase included in the metal layer, after the assembling step.
